(19) United States
(12) Patent Application Publication
(10) Pub. No.: US 2002/0087594 A1
(43) Pub. Date: Jul. 4, 2002

(54) Methods, systems and computer program products for subscriber customized generation of publications

(75) Inventor: Mark E. Peters, Chapel Hill, NC (US)

Correspondence Address: Timothy J. O'Sullivan, Myers Bigel Sibley & Sajovec, Post Office Box 37428, Raleigh, NC, 27627, US

(73) Assignee: International Business Machines Corporation, Armonk, NY (US)

(21) Appl. No.: 09/753,882

(22) Filed: Jan. 3, 2001

(51) Int. Cl. G06F 17/24

(52) U.S. Cl. 707/511; 707/530

(57) ABSTRACT

Embodiments of the present invention include methods, systems and computer program products which provide for subscriber based generation of a customized publication. A subscriber list is generated including identifications of a plurality of subscribers for the publication. The subscriber list is provided to a content provider and a designation of different selected content for two or more individual subscribers is received from the content provider. The designated selected contents are associated with respective subscribers based on the identifications of the subscribers. Versions of the publication are generated including the respective different selected contents for the subscribers.

### FIELD OF THE INVENTION

The present invention relates to customized publications and more particularly to selection of content for such publications.

### BACKGROUND OF THE INVENTION

In advertising, it is considered highly desirable to target advertisements to the appropriate potential customer base, rather than to broadcast advertisements in general. Such targeted advertising has been developed extensively on the Internet for on-line advertising and, to a limited degree, for publications such as periodicals and newspapers.

For publications, it is known to provided different versions of a publication for different geographic distribution regions. For example, U.S. Pat. No. 5,143,362 is directed to methods and apparatus for publication personalization where different versions of a publication are generated and then personalized address and identification information is printed on the publications. Different versions may include a different demographic form of the personalized signature with the form being detectable during printing to facilitate linking the form to the address information. U.S. Pat. Nos. 4,149,711, 5,114,128, 5,419,541 and 5,819,241 are also directed to assembling personalized publications.

In the Internet context, on-line advertisements conventionally appear on the top or bottom of a web page as a banner. When a user views a web page displaying a banner advertisement, the user may then try to find out more information regarding the advertisement (or the company providing the advertisement) by selecting the advertisement (“clicking through” on the banner ad) through the use of the mouse or other pointing device.

By tracking the viewing and buying patterns of on-line consumers, many on-line companies seek to determine the “right” advertisement to be displayed to each potential customer. Many on-line companies hope that, by tailoring advertising to individuals, they will increase the likelihood that a consumer will read and act upon the advertising.

### SUMMARY OF THE INVENTION

Embodiments of the present invention include methods, systems and computer program products which provide for subscriber based generation of a customized publication. A subscriber list is generated including identifications of a plurality of subscribers for the publication. The subscriber list is provided to a content provider and a designation of different selected content for two or more individual subscribers is received from the content provider. A first of the designated selected contents is associated with a first one of the subscribers based on the identification of the first subscriber. A second of the designated selected contents, different from the first, is associated with a second of the subscribers different from the first subscriber based on the identification of the second subscriber. A first version of the publication is generated including the first selected content for the first subscriber and a second version of the publication is generated including the second selected content for the second subscriber.

In other embodiments of the present invention, the content provider is an advertiser and the first selected content and the second selected content are advertisements. The first version of the publication may be generated including the first selected content in a prescribed field of the publication for the first subscriber and the second version of the publication may be generated including the second selected content in the same prescribed field of the publication for the second subscriber.

In further embodiments of the present invention, operations include integrating content not designated by the content provider into the first version of the publication and the second version of the publication. The first version and the second version of the publication are printed and distributed to the associated ones of the subscribers.

In other embodiments of the present invention, a content provider receives at least a portion of the subscriber list. The content provider determines if any individually targeted content from the content provider is to be provided in the publication for ones of the subscribers. If any individually targeted content is to be provided in the publication for the subscribers, the content provider further obtains designations of content as the designations of the selected content for the associated subscribers based on the identifications of the subscribers. These designations of content are transmitted as the designations of the selected content. The designation of content may be the selected content. Alternatively, the designations of content may comprise identifiers of information, for example, of information maintained by a printer of the publication, which identifiers may be transmitted to the printer of the publication.

In further embodiments of the present invention, determining if any individually targeted content from the content provider is to be provided further includes determining if any individually targeted content is to be provided based on individual profile information maintained by the content provider for the subscribers. The content provider may be an advertising distributor, in which case, the advertising distributor may determine if any individually targeted content from the content provider is to be provided by identifying target advertisers for ones of the subscribers based on the individual profile information for the respective ones of the subscribers. Designations of content associated with the identified target advertisers are obtained for the respective ones of the subscribers.

In yet other embodiments of the present invention, systems are provided for subscriber based generation of a customized publication. A subscriber list is provided including identifications of a plurality of subscribers for the publication. A profile data base is provided including profile information about ones of the plurality of subscribers. A content identification circuit associates different content with respective ones of the plurality of subscribers based on the identifications of the plurality of subscribers from the subscriber list and the profile information about the respective ones of the plurality of subscribers from the profile database. A print control circuit operatively coupled to the content identification circuit generates versions of the publication for respective ones of the plurality of subscribers including associated different content for respective ones of the plurality of subscribers. A printer prints the generated versions of the publication responsive to the print control circuit.

The profile database may be associated with a content provider system remote from the content identification circuit, the print control circuit and the printer. The content provider system includes a determination circuit that determines if any individually targeted content is to be provided in the publication for respective ones of the plurality of subscribers and a content generation circuit that generates individualized content for respective ones of the plurality of subscribers. The content provider system may further include an output circuit that provides the generated individualized content to the content identification circuit.

While the invention has been described above primarily with respect to the method aspects of the invention, both systems and/or computer program products are also provided.

### BRIEF DESCRIPTION OF THE DRAWINGS

FIG. 1 is a block diagram of an environment in which embodiments of the present invention are implemented;

FIG. 2 is a block diagram of data processing systems according to embodiments of the present invention;

FIG. 3 is a more detailed block diagram of data processing systems according to embodiments of the present invention;

FIG. 4 is a flowchart illustrating operations according to embodiments of the present invention; and

FIG. 5 is a flowchart illustrating operations according to embodiments the present invention.

### DETAILED DESCRIPTION OF PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit.” Furthermore, the present invention may take the form of a computer program product on a computer-usable storage medium having computer-usable program code means embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

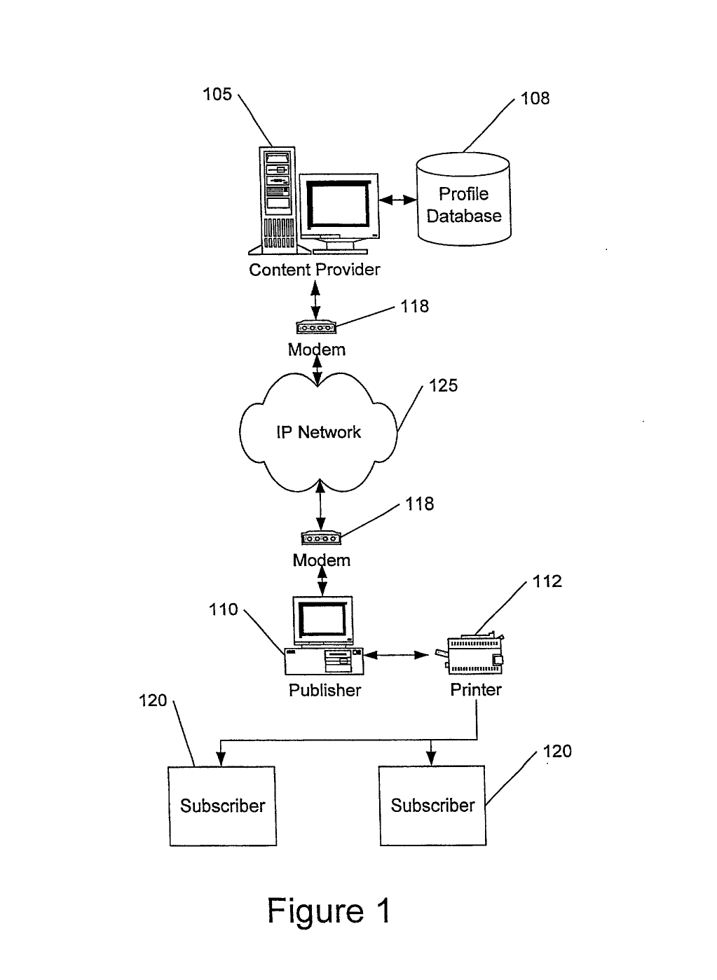

Referring first to the block diagram illustration of FIG. 1, embodiments of the present invention implemented in an Internet protocol (IP) network environment will now be described. As illustrated in FIG. 1, a content provider system 105, operatively coupled to a profile database 108, connects to the IP network 125 through a modem 118 or other communication means, such as a digital subscriber line, cable modem, network adaptor or the like. A publisher system 110 similarly connects to the IP network 125 through a modem 118 or other communication means. The publisher system 110 is operatively coupled to a printer 112. The printer 112 may be a high volume printer configured for printing of customized publications in accordance with the teachings of the present invention. The customized publications generated by the printer 112 are, in turn, distributed to associated ones of a plurality of subscribers 120.

In various embodiments, the content provider is an advertiser or advertising distributor with information about various ones of the subscribers 120 maintained in the profile database 108 to facilitate targeted advertising. The publisher may be a publisher of a periodical, such as a magazine, newspaper or other printed publication having an associated subscriber list.

The IP network 125 may be used for transmission of subscriber list information from the publisher system 110 to the content provider system 105 and further for communication of targeted content from the content provider system 105 to the publisher system 110. However, it is also to be understood that either of these information exchanges may be implemented by other means, such as generating printed documentation which may be shipped between the content provider and the publisher and, as necessary, keyed into the respective content provider system 105 and publisher system 110.

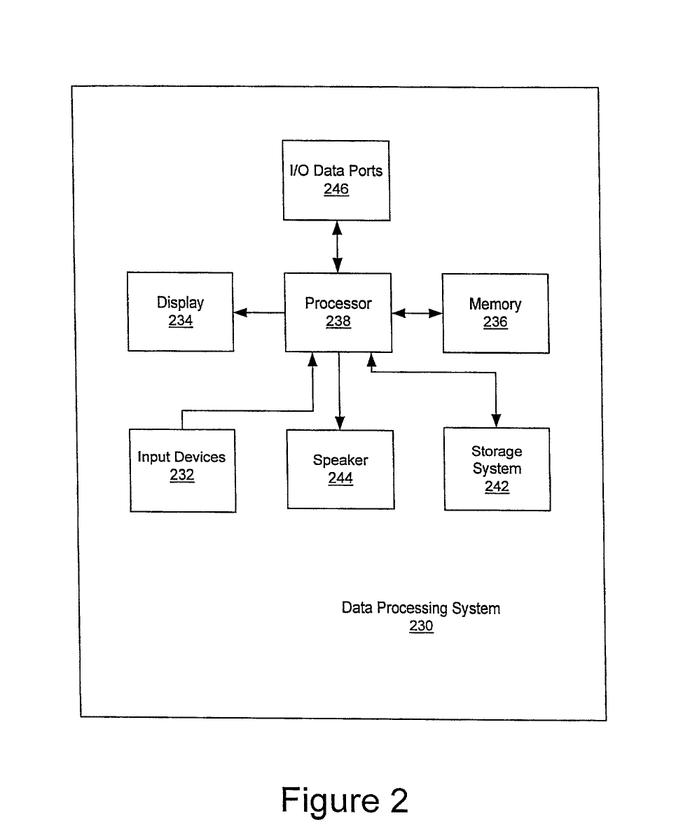

The present invention will now be further described with reference to the block diagram of FIG. 2 which illustrates data processing systems according to embodiments of the present invention. As illustrated in FIG. 2, the system 230 may include input device(s) 232 such as a keyboard or keypad, a display 234, and a memory 236 that communicate with a processor 238. The data processing system 230 may further include a storage system 242, a speaker 244 and an I/O data port(s) 246 that also communicate with the processor 238. The storage system 242 may include removable and/or fixed media such as floppy disks, ZIP drives, hard disks or the like as well as virtual storage such as a RAMDISK. The I/O data port(s) 246 can be used to transfer information between the data processing system 230 and another computer system or a network (e.g., the Internet). Such data processing systems may include, for example, personal computers, laptop computers, mainframe computers, pervasive computing devices such as personal digital assistants, smartphones or the like, or even embedded processing systems. The components of a particular data processing system may be conventional or custom components, such as those used in many conventional computing devices, which may be configured to operate as described herein.

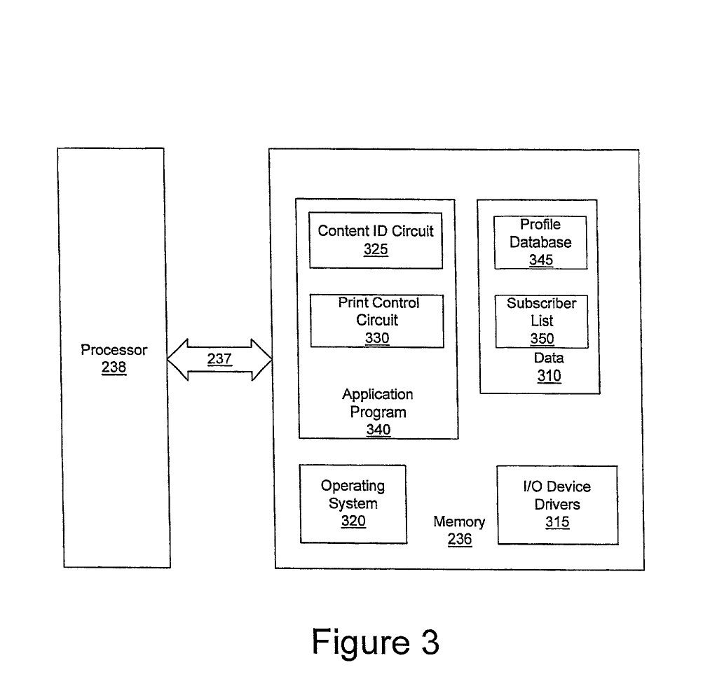

FIG. 3 is a block diagram of a data processing system that illustrates systems, methods, and computer program products in accordance with embodiments of the present invention. The processor 238 communicates with the memory 236 via an address/data bus 237. The processor 238 can be a commercially available or custom microprocessor. The memory 236 is representative of the overall hierarchy of memory devices containing the software and data used to implement the functionality of the data processing system 230. The memory 236 can include, but is not limited to, the following types of devices: cache, ROM, PROM, EPROM, EEPROM, flash memory, SRAM, and DRAM.

As shown in FIG. 3, the memory 236 may contain several categories of software and data used in the data processing system 230: the operating system 320; the application program 340; the input/output (I/O) device drivers 315; and the data 310. As will be appreciated by those of skill in the art, the operating system 320 may be any operating system suitable for use with a data processing system, such as OS/2, AIX or OS/390 from International Business Machines Corporation, Armonk, N.Y., WindowsCE, WindowsNT, Windows95, Windows98 or Windows2000 from Microsoft Corporation, Redmond, Wash., PalmOS from Palm, Inc., MacOS from Apple Computer, UNIX or Linux, proprietary operating systems or dedicated operating systems, for example, for embedded data processing systems.

The I/O device drivers 315 typically include software routines accessed through the operating system 320 by the application program 340 to communicate with devices such as the input devices 232, the display 234, the speaker 244, the storage system 242, the I/O data port(s) 246, and certain memory 236 components. The application program 340 is illustrative of the programs that implement the various features of the data processing system 230. Finally, the data 310 represents the static and dynamic data used by the application program 340, operating system 320, I/O device drivers 315, and other software programs that may reside in the memory 236.

As shown in FIG. 3 an embodiment of a publisher system 110 in accordance with the present invention includes a content identification circuit 335 and a print control circuit 330 in the application program 340. In addition, the data 310 includes a profile database 345 and a subscriber list 350. The subscriber list 350 includes identifications of a plurality of subscribers for the publication. The profile database includes profile information about ones of the plurality of subscribers. While the profile database 345 is illustrated in FIG. 3 as being associated with the publisher system 110, it is to be understood that the profile database 345 may also be associated with a data processing system associated with the content provider system 105 such as the profile database 108. Furthermore, such profile information may be maintained by both the content provider and the publisher.

The content identification circuit 325, as illustrated in FIG. 3, associates different content with respective ones of the plurality of the subscribers. The association may be based on identifications of the individual ones of the plurality of subscribers from the subscriber list 350 and profile information about the respective ones of the plurality of subscribers from the profile database 345. For example, a subscriber name may be used as an identifier in the subscriber list 350. Alternatively, an alphanumeric identifier unique to an individual subscriber may be used as the identifying term in the subscriber list 350.

The print control circuit 330 is operatively coupled to the content identification circuit 325 and generates versions of the publication for respective ones of the plurality of subscribers. Different associated content customized for respective ones of the subscribers is included in the respective versions for the individual subscribers. The output from the print control circuit 330 may then be provided to a printer 112 that prints the generated versions of the publication responsive to the print control circuit 330. The interface to such an external printer may be provided by one of the I/O device drivers 315 operating through the I/O data ports 246 of the data processing system 230.

For a data processing system 230 supporting a content provider system 105, the application program 340 in various embodiments includes a determination circuit and a content generation circuit. The determination circuit may determine if any individually targeted content is to be provided in the publication for respective ones of the subscribers in the subscriber list 350. The content provider's content generation circuit may then generate individualized content for respective ones of the subscribers. The content provider system 105 preferably also has an output circuit, such as the I/O device drivers 315 through the I/O data ports 246 that provides the generated individualized content to the content identification circuit 325. For example, the communications between the publisher and the content provider may be over the IP network 125 through the modems 118 as shown in the environment of FIG. 1. However, the communications of subscriber lists and content information may, alternatively, be provided through hard copy print out information and transmission of such information which, in turn, may be keyed into respective data processing systems at the publisher 110 and content provider 105.

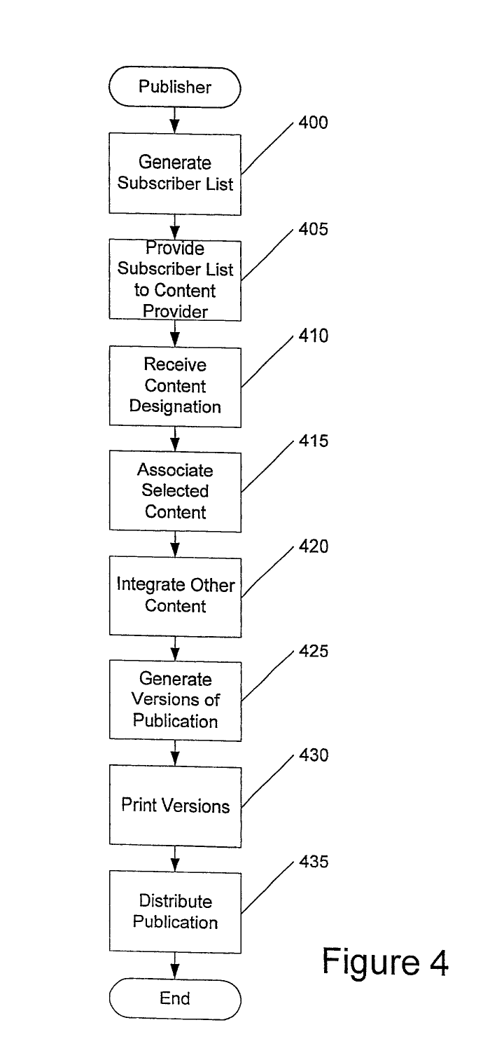

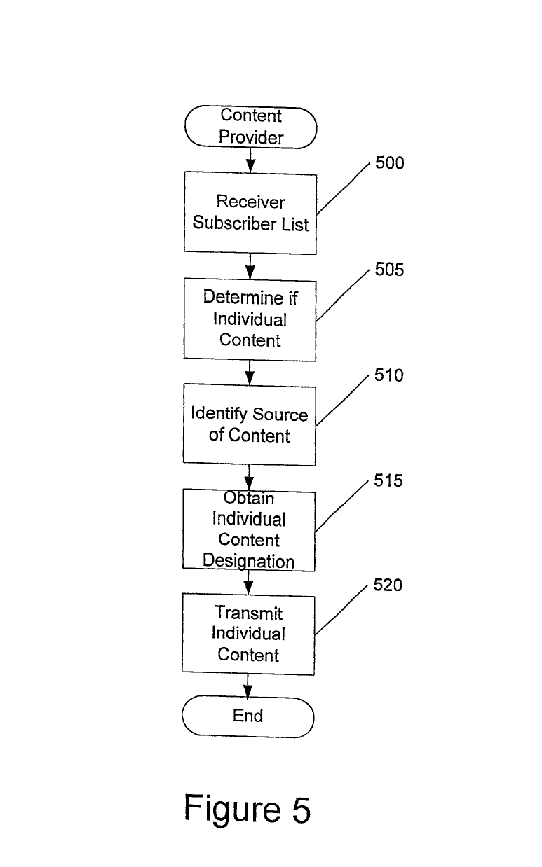

Operations according to various embodiments of the present invention for subscriber based generation of a customized publication will now be further described with reference to the flowchart illustrations of FIGS. 4 and 5. Operations carried out by the publisher begin with reference to FIG. 4 at block 400 with generation of a subscriber list, including identifications of a plurality of subscribers for the publication. In various embodiments of the present invention, operations related to the content generation are provided by one or more content providers separate from the publisher as will be described with reference to blocks 405 and 410. In such embodiments, at least a portion of the subscriber list, including identifications of ones of the plurality of subscribers is provided to the content provider(s) by the publisher (block 405). A designation of selected content for respective ones of the subscribers is received by the publisher from the content provider(s) (block 410).

The content provider(s) may be an advertiser in which case the content information is typically advertisements targeted to specific individuals, for example, based on their buying preferences. Selected content for individual ones of the subscribers is associated with the respective subscribers based on the identification of the subscribers (block 415). Based on individual subscriber identifications and the designation of content for the individual subscriber identifications from the content provider(s), the publisher associates customized, individualized content with ones of the individual subscribers.

The individualized information may be integrated with general content (not designated by the customized content) into various versions of the publication for respective ones of the individual subscribers (block 420). Versions of the publication are generated including the customized individualized content for respective ones of the individual subscribers (block 425). In various embodiments of the present invention, the customized individual content for each subscriber may be placed in a prescribed field of the publication. For example, a designated advertisement box integrated with articles or text of other interest associated with the theme of the publication may present a unique advertisement for different ones of the subscribers. Alternatively, the selected content may not be so constrained and may, for example, cause the overall format of the publication in each respective version to vary based upon a variety of individualized content which is included for each subscriber.

The generated versions of the publication for respective ones of the individual subscribers are then printed (block 430). Such individualized printing capabilities may be provided through known high volume printers such as the Infoprint 4000 available from International Business Machines Corporation (IBM). The respective printed versions of the publication are distributed to the associated subscribers (block 435). For example, a magazine, newspaper or other periodical may be mailed, after printing, to the respective subscribers. Thus, targeted advertising or other customization of publications may be provided on an individual by individual level as contrasted with other version criteria, such as geographic region.

Operations with reference to the content provider system 105 will now be described for various embodiments of the present invention with reference to the flowchart illustration of FIG. 5. At least a portion of the subscriber list 350 is received at the content provider (block 500). The content provider determines if any individually targeted content from the content provider is to be provided to one or more of the subscribers identified in the subscriber list (block 505).

In various embodiments of the present invention, operations further include identifying a source of content to be provided to individual ones of the subscribers (block 510). For example, in embodiments of the present invention, the content provider is an advertising distributor who may obtain rights to advertising space in the publication and then sell access to the space on behalf of individual advertisers based on subscriber criteria. In such an embodiment, operations related to identifying a source of customized content may include identifying one or more target advertisers for various ones of the subscribers based on profile information associated with the subscribers in the profile database 345.

Designations of content for respective ones of the individual subscribers who have been determined to have individualized targeted content are obtained by the content provider (block 515). The obtained designations of content may comprise the actual content to be included, or an identifier of information to be included. The identifier may be an identifier of information maintained, for example, by the publisher. Similarly, where the content provider is an advertising distributor and the content is associated with different target advertisers, operations in obtaining the individual content may include obtaining the content from respective identified target advertisers or from associated databases maintained by the content provider including associated content for respective target advertisers. The designation of content for respective subscribers is then transmitted, for example, to the publisher (block 520).

Operations according to the present invention may be further understood in the context of control of advertisements by publishers. A publisher, for example, of a periodical, could make subscription lists available to their advertisers for purposes of allowing the advertiser to look up a consumer on the subscription list and customize content based upon information that the advertiser knows about the consumer. The information known about the consumer could further be provided in part, or in total, to the advertiser by the publisher.

For example, if Amazon.com advertises in Business Week, then Business Week could, either in batch or in real time, ask Amazon.com for an advertisement to include in a version of Business Week sent to a subscriber “X.” If Amazon.com has specific knowledge of subscriber X, then Amazon.com can suggest, for example, new books that are like old ones that subscriber X has previously purchased. Alternatively, Amazon.com could use various data mining techniques to suggest books in which subscriber X might be interested based on a variety of profile information related to subscriber X. This profile information could be provided by the publisher, third party information sources or maintained by the advertiser itself.

Individually customized content in accordance with the present invention for inclusion in a publication, such as a periodical, need not be limited to advertisements. For example, newspapers and/or magazines could utilize the present invention to print articles likely to be of the most interest to individual subscribers based on information known to the publisher, advertisers or other third parties to customize substantive content in the publication for individual subscribers. Such targeting publications may even provide for free publications to the subscribers where the subscribers have provided profile information that facilitates effective targeted marketing so as to allow the costs for generation and delivery of the publications to be absorbed by advertising revenues.

The flowcharts and block diagrams of FIGS. 1 through 5 illustrate the architecture, functionality, and operation of possible implementations of systems, methods and computer program products for subscriber based generation of a customized publication according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved.

In the drawings and specification, there have been disclosed typical preferred embodiments of the invention and, although specific terms are employed, they are used in a generic and descriptive sense only and not for purposed of limitation, the scope of the invention being set forth in the following claims.

That which is claimed:

1. A method for subscriber based generation of a customized publication comprising the steps of:
generating a subscriber list including identifications of a plurality of subscribers for the publication;
providing, to a content provider, at least a portion of the subscriber list including identifications of a first of the subscribers and a second of the subscribers different from the first subscriber;
receiving a designation of a first selected content and a second selected content from the content provider;
associating the first selected content with the first subscriber based on the identification of the first subscriber;
associating the second selected content, different from the first selected content, with the second subscriber based on the identification of the second subscriber; and then
generating a first version of the publication including the first selected content for the first subscriber; and
generating a second version of the publication including the second selected content for the second subscriber.

2. The method of claim 1 wherein the content provider is an advertiser and the first selected content and the second selected content are advertisements.

3. The method of claim 2 wherein the step of receiving a designation of a first selected content and a second selected content from the content provider further comprises the step of receiving a designation of a first selected content based on buying preferences of the first subscriber and a second selected content based on buying preferences of the second subscriber from the content provider.

4. The method of claim 2 wherein the step of generating a first version comprises the step of generating a first version of the publication including the first selected content in a prescribed field of the publication for the first subscriber and wherein the step of generating a second version comprises the step of generating a second version of the publication including the second selected content in the prescribed field of the publication for the second subscriber.

5. The method of claim 1 further comprising the steps of:
integrating content not designated by the content provider into the first version of the publication and the second version of the publication;
printing the first version and the second version of the publication; and
distributing the printed first version of the publication to the first and the printed second version of the publication to the second subscriber.

6. The method of claim 1 further comprising the steps performed by the content provider of:
receiving the at least a portion of the subscriber list;
determining if any individually targeted content from the content provider is to be provided in the publication for the first subscriber;
determining if any individually targeted content from the content provider is to be provided in the publication for the second subscriber;
obtaining a first designation of content as the designation of the first selected content based on the identification of the first subscriber if any individually targeted content is to be provided in the publication for the first subscriber;
obtaining a second designation of content as the designation of the second selected content based on the identification of the second subscriber if any individually targeted content is to be provided in the publication for the second subscriber; and
transmitting the first designation of content and the second designation of content respectively as the designation of the first selected content and the second selected content.

7. The method of claim 6 wherein the first designation of content comprises the first selected content.

8. The method of claim 6 wherein the first designation of content comprises a first identifier of information maintained by a printer of the publication and wherein the step of transmitting the first designation of content further comprises the step of transmitting the first identifier to the printer of the publication.

9. The method of claim 6 wherein the steps of determining if any individually targeted content from the content provider is to be provided further comprise determining if any individually targeted content is to be provided based on individual profile information maintained by the content provider for each of the first and second subscribers.

10. The method of claim 9 wherein the content provider is an advertising distributor and wherein the steps of determining if any individually targeted content from the content provider is to be provided includes the steps performed by the advertising distributor of:
identifying a first target advertiser for the first subscriber based on the individual profile information for the first subscriber;
identifying a second target advertiser for the second subscriber based on the individual profile information for the second subscriber; and
wherein the step of obtaining a first designation of content further comprises the step of obtaining a designation of content associated with the identified first target advertiser; and
wherein the step of obtaining a second designation of content further comprises the step of obtaining a designation of content associated with the identified second target advertiser.

11. A system for subscriber based generation of a customized publication comprising:
a subscriber list including identifications of a plurality of subscribers for the publication;
a profile data base including profile information about ones of the plurality of subscribers;
a content identification circuit that associates different content with respective ones of the plurality of subscribers based on the identifications of the plurality of subscribers from the subscriber list and the profile information about the respective ones of the plurality of subscribers from the profile database;
a print control circuit operatively coupled to the content identification circuit that generates versions of the publication for respective ones of the plurality of subscribers including associated different content for respective ones of the plurality of subscribers;
a printer that prints the generated versions of the publication responsive to the print control circuit; and
wherein the profile database is associated with a content provider system remote from the content identification circuit, the print control circuit and the printer, the content provider system further comprising:
a determination circuit that determines if any individually targeted content is to be provided in the publication for respective ones of the plurality of subscribers;
a content generation circuit that generates individualized content for respective ones of the plurality of subscribers; and
an output circuit that provides the generated individualized content to the content identification circuit.

12. The system of claim 11 wherein the profile information includes information about buying preferences of the ones of the plurality of subscribers.

13. A system for subscriber based generation of a customized publication comprising:
a subscriber list including identifications of a plurality of subscribers for the publication;
means for providing, to a content provider, at least a portion of the subscriber list including identifications of a first of the subscribers and a second of the subscribers different from the first subscriber;
means for receiving a designation of a first selected content and a second selected content from the content provider;
means for associating the first selected content with the first subscriber based on the identification of the first subscriber;
means for associating the second selected content, different from the first selected content, with the second subscriber based on the identification of the second subscriber;
means for generating a first version of the publication including the first selected content for the first subscriber; and
means for generating a second version of the publication including the second selected content for the second subscriber.

14. The system of claim 14 wherein the content provider is an advertiser and the first selected content and the second selected content comprise advertisements.

15. The system of claim 14 wherein the means for receiving a designation further comprises means for receiving a first selected content based on buying preferences of the first subscriber and a second selected content based on buying preferences of the second subscriber from the content provider.

16. The system of claim 14 wherein the means for generating a first version comprises means for generating a first version of the publication including the first selected content in a prescribed field of the publication for the first subscriber and wherein the means for generating a second version comprises means for generating a second version of the publication including the second selected content in the prescribed field of the publication for the second subscriber.

17. The system of claim 14 further comprising:
means for integrating content not designated by the content provider into the first version of the publication and the second version of the publication;
a printer that prints the first version and the second version of the publication; and
means for distributing the printed first version of the publication to the first subscriber and the printed second version of the publication to the second subscriber.

18. The system of claim 14 further comprising a content provider system comprising:
means for receiving the at least a portion of the subscriber list;
means for determining if any individually targeted content from the content provider is to be provided in the publication for the first subscriber;
means for determining if any individually targeted content from the content provider is to be provided in the publication for the second subscriber;
means for obtaining a first designation of content as the designation of the first selected content based on the identification of the first subscriber if any individually targeted content is to be provided in the publication for the first subscriber;
means for obtaining a second designation of content as the designation of the second selected content based on the identification of the second subscriber if any individually targeted content is to be provided in the publication for the second subscriber; and
means for transmitting the first designation of content and the second designation of content respectively as the designation of the first selected content and the second selected content.

19. The system of claim 18 wherein the first designation of content comprises the first selected content.

20. The system of claim 18 wherein the first designation of content comprises a first identifier of information maintained by a printer of the publication and wherein the means for transmitting the first designation of content further comprises means for transmitting the first identifier to the printer of the publication.

21. The system of claim 18 wherein the means for determining if any individually targeted content from the content provider is to be provided further comprise means for determining if any individually targeted content is to be provided based on individual profile information maintained by the content provider for each of the first and second subscribers.

22. The system of claim 21 wherein the content provider is an advertising distributor and wherein the means for determining if any individually targeted content from the content provider is to be provided include an advertising distributor system comprising:
means for identifying a first target advertiser for the first subscriber based on the individual profile information for the first subscriber;
means for identifying a second target advertiser for the second subscriber based on the individual profile information for the second subscriber; and
wherein the means for obtaining a first designation of content further comprises means for obtaining a designation of content associated with the identified first target advertiser; and
wherein the means for obtaining a second designation of content further comprises means for obtaining a designation of content associated with the identified second target advertiser.

23. A computer program product for subscriber based generation of a customized publication, comprising:
a computer-readable storage medium having computer-readable program code embodied in said medium, said computer-readable program code comprising:
a subscriber list including identifications of a plurality of subscribers for the publication;
computer-readable program code which provides, to a content provider, at least a portion of the subscriber list including identifications of a first of the subscribers and a second of the subscribers different from the first of the subscribers;
computer-readable program code which receives a designation of the first selected content and the second selected content from the content provider;
computer-readable program code which associates a first selected content with the first subscriber based on the identification of the first subscriber;
computer-readable program code which associates a second selected content, different from the first selected content, with the second subscriber based on the identification of the second subscriber;
computer-readable program code which generates a first version of the publication including the first selected content for the first subscriber; and
computer-readable program code which generates a second version of the publication including the second selected content for the second subscriber.

24. The computer program product of claim 23 wherein the content provider is an advertiser and the first selected content and the second selected content comprise advertisements.

25. The computer program product of claim 24 wherein the computer-readable program code which receives a designation of the first selected content and the second selected content from the content provider further comprises computer-readable program code which receives a designation of the first selected content based on buying preferences of the first subscriber and the second selected content based on buying preferences of the second subscriber from the content provider.

26. The computer program product of claim 24 wherein the computer-readable program code which generates a first version comprises computer-readable program code which generates a first version of the publication including the first selected content in a prescribed field of the publication for the first subscriber and wherein the computer-readable program code which generates a second version comprises computer-readable program code which generates a second version of the publication including the second selected content in the prescribed field of the publication for second subscriber.

27. The computer program product of claim 24 further comprising:
computer-readable program code which integrates content not designated by the content provider into the first version of the publication and the second version of the publication; and
computer-readable program code which initiates distribution of the first version of the publication to the first subscriber and the second version of the publication to the second subscriber.

28. The computer program product of claim 24 further comprising a content provider computer program product comprising:
computer-readable program code which receives the at least a portion of the subscriber list;
computer-readable program code which determines if any individually targeted content from the content provider is to be provided in the publication for the first subscriber;
computer-readable program code which determines if any individually targeted content from the content provider is to be provided in the publication for the second subscriber;
computer-readable program code which obtains a first designation of content as the designation of the first selected content based on the identification of the first subscriber if any individually targeted content is to be provided in the publication for the first subscriber;
computer-readable program code which obtains a second designation of content as the designation of the second selected content based on the identification of the second subscriber if any individually targeted content is to be provided in the publication for the second subscriber; and
computer-readable program code which transmits the first designation of content and the second designation of content respectively as the designation of the first selected content and the second selected content.

29. The computer program product of claim 28 wherein the first designation of content comprises the first selected content.

30. The computer program product of claim 28 wherein the first designation of content comprises a first identifier of information maintained by a printer of the publication and wherein the computer-readable program code which transmits the first designation of content further comprises computer-readable program code which transmits the first identifier to the printer of the publication.

31. The computer program product of claim 28 wherein the computer-readable program code which determines if any individually targeted content from the content provider is to be provided further comprise computer-readable program code which determines if any individually targeted content is to be provided based on individual profile information maintained by the content provider for each of the first and second subscribers.

32. The computer program product of claim 31 wherein the content provider is an advertising distributor and wherein the computer-readable program code which determines if any individually targeted content from the content provider is to be provided include an advertising distributor computer program product comprising:
computer-readable program code which identifies a first target advertiser for the first subscriber based on the individual profile information for the first subscriber;
computer-readable program code which identifies a second target advertiser for the second subscriber based on the individual profile information for the second subscriber; and
wherein the computer-readable program code which obtains a first designation of content further comprises computer-readable program code which obtains a designation of content associated with the identified first target advertiser; and
wherein the computer-readable program code which obtains a second designation of content further comprises computer-readable program code which obtains a designation of content associated with the identified second target advertiser.
